(19) United States
(12) Patent Application Publication
(10) Pub. No.: US 2021/0276785 A1
(43) Pub. Date: Sep. 9, 2021

(54) AIRLESS TYPE MIXING CONTAINER FOR TWO KINDS OF CONTENTS CAPABLE OF DISCHARGING ALL CONTENTS

(71) Applicant: TAESUNG INDUSTRIAL CO., LTD., Anyang-si (KR)

(72) Inventor: Kam Sub SONG, Yongin-si (KR)

(21) Appl. No.: 17/139,611

(22) Filed: Dec. 31, 2020

(30) Foreign Application Priority Data
Mar. 9, 2020 (KR) 10-2020-0028999

(51) Int. Cl. B65D 81/32; B65D 83/00; B65D 51/28

(52) U.S. Cl. CPC B65D 81/3222; B65D 2217/00; B65D 51/2814; B65D 83/0033

(57) ABSTRACT

Provided is an airless type mixing container for two kinds of contents capable of discharging all the contents, in which two kinds of substances may be separately accommodated and easily used by mixing the separately accommodated substances. The mixing container is configured such that an auxiliary container mounting member is mounted so as to be positioned on a content receiving part of a main container in which one of two kinds of contents is accommodated, and an auxiliary container in which the other of the two kinds of contents is stored is mounted on the auxiliary container mounting member, so that the two different kinds of contents are respectively stored. When a content discharge pumping member is deeply pressed, as the auxiliary container mounted on the auxiliary container mounting member is released from a body of the auxiliary container mounting member, the two kinds of substances are mixed together.

### CROSS REFERENCE TO RELATED APPLICATION

The present application claims priority to Korean Patent Application No. 10-2020-0028999, filed Mar. 09, 2020, the entire contents of which is incorporated herein for all purposes by this reference.

### BACKGROUND OF THE INVENTION

### Field of the Invention

The present disclosure relates to a mixing container for two kinds of contents, the mixing container being capable of separating and accommodating two kinds of substances and allowing easy mixing and use of the two kinds of substances that are separately accommodated and, more particularly, to a mixing container for two kinds of contents in which cost of production may be lowered by simplifying a production process in accordance with assembly production by way of providing a simplified structure as well as improving the structure so as to resolve a defect in which contents in a container is remained as a residue, resulting as an emerging drawback of an airless type mixing container for two kinds of contents and enabling stable discharge so as to ensure that the contents are always adjacent to a discharge pump at a constant level by increasing a height of the contents that is filled while a piston moves upward depending on a vacuum generated in the container.

### Description of the Related Art

In general, in the fields of medicines and cosmetics, when substances having different components or two substances (hereinafter referred to as “two kinds”) are mixed and used, compared to a case where a single kind of substance is used, new types of medicines and cosmetics having new qualities and effects are created.

By mixing and using the substances as described above, methods of mixing and using medicines or cosmetics to obtain the effect and new quality are divided into two types.

In one of the above two types, contents filled and stored in each container are mixed and used after putting two kinds of contents in a separate container in an appropriate ratio every time a user uses the contents.

Since the method of mixing and using contents after taking out two kinds of contents in separate containers is cumbersome in use, at present, a mixing container for two kinds of contents has been developed that allows the two kinds of contents to be separately stored and then used by mixing the contents when in use.

The mixing containers for two kinds of contents are largely divided into a dip-tube type mixing container for two kinds of contents and an airless type mixing container for two kinds of contents.

The two types of mixing containers for two kinds of contents have various structures and have been developed in various ways.

As an airless type mixing container for two kinds of contents in comparison with the invention applied for this case, the “COSMETIC VESSEL HAVING MIXED TWO-TYPE MATERIALS)” of Korean Patent No. 10-1192603 (hereinafter referred to as a pre-registered invention) may be referenced as an example among the above mixing containers for two kinds of contents.

The mixing container for two kinds of contents in the pre-registered invention is devised to cause an inside of a container filled with two kinds of contents to be a vacuum state, so that a piston positioned at the bottom surface of the container is pulled upward by vacuum pressure to push the contents toward a discharge pump, thereby stably discharging the mixed two kinds of contents.

The mixing container for two kinds of contents of the above pre-registered invention will be described with reference to FIGS. 7 to 8 as follows.

In the mixing container for two kinds of contents of the pre-registered invention, a receiving member 510 in which a content having a component different from that of the content accommodated in a storage chamber 110 of a housing 100 is accommodated is assembled and formed on a guide bracket 200 that is assembled to an upper part of the housing 100 that includes the storage chamber 110 in which one of two kinds of contents is accommodated, and at the same time an open lower part of the receiving member 510 is blocked by a sealing member 520 connected to and provided with a pumping member 320, whereby one of the two kinds of contents is accommodated and stored therein.

As described above, when a user desires to mix and use two kinds of contents separately stored in the storage chamber 110 of the housing 100 and the receiving member 510 in a mixing container for two kinds of contents, a button part 300 is to be deeply pressed, so that the sealing member 520 connected to the pumping member 320 and blocking the receiving member 510 is made to be spaced apart.

As the sealing member 520 is spaced apart from the receiving member 510, the content accommodated in the receiving member 510 is mixed with the content accommodated in the storage chamber 110 of the housing 100.

When the contents respectively accommodated in the storage chamber 110 and the receiving member 510 are mixed, the mixing container for two kinds of contents is shaken so that the two kinds of contents are evenly mixed, and then discharged and used.

In discharging the two kinds of contents, when the button part 300 is pressed, the pumping member 320 interlocking with the button part 300 is pumped and a vacuum is generated in the storage chamber 110 of the housing 100.

When the vacuum occurs in the storage chamber 110 of the housing 100, the piston 120, which is positioned at the bottom of the storage chamber 110, rises upward by the vacuum pressure and pumps upward the two kinds of contents by means of the pumping member 320.

The mixing container for two kinds of contents operated as above is called an airless type mixing container.

In the pre-registered invention described above, there is an advantage in that a structure of the airless type mixing container has been improved so that the receiving member 510 may be easily opened, whereby two kinds of contents may be easily mixed and used. Whereas, there are disadvantages in that since the structure is provided such that an opening part of the receiving member is positioned downward, and as an assembly of the sealing member 520 is completed in a state of being connected to the pumping member 320, interference of the sealing member 520 occurs while filling the contents, a hassle occurs in which the button member 300 has to be turned upside down so as to position the receiving member 510 upside down, and a structural defect in which many spaces exist below and above the sealing member 520 occurs in a state where the piston 120 is completely raised above the storage chamber 110 of the housing 100, so that waste of the expensive two kinds of contents is inevitable, thereby being unable to improve product reliability of consumers.

### SUMMARY OF THE INVENTION

An embodiment of the present disclosure is developed to solve the disadvantages of the pre-registered invention, and an objective of the embodiment of the present disclosure is to provide an airless type mixing container for two kinds of contents, wherein an auxiliary container in which a content of a component different from that of the content accommodated in a main container are accommodated is assembled on an auxiliary container mounting member positioned in an upper inner side of the main container in which one of the two kinds of contents is accommodated in an airtight state with respect to the auxiliary container mounting member, so that the accommodated content of the auxiliary container is not mixed with the content of the main container and may be stably separated and stored, as well as when in use, the auxiliary container is lowered from the auxiliary container mounting member by a deep pressing operation of a push button constituting a contents discharging pump member, so as to enable mixing of the two kinds of contents while releasing the airtightness and to enable discharging all the mixed two kinds of contents when in use.

In the embodiment of the present disclosure for achieving the above objective, there is provided an airless type mixing container for two kinds of contents, in which the two kinds of contents are separately stored and are able to be used by mixing, the airless type mixing container being capable of discharging all the contents and including: a main container having an opening part formed with a screw thread having an outer circumferential surface thereof on which a shoulder of a contents discharge pumping member is assembled, the opening part having a narrowed upper part thereof in a through-type tube shape, and having a finishing cap assembled therein and provided with an air inlet hole at a lower part thereof where a piston is assembled, the main container accommodating one of the two kinds of contents; an auxiliary container mounting member being positioned inside of a content receiving part through the opening part at the upper part of the main container so that a flange at an upper part thereof is locked by an upper edge part of the opening part, and having a locking annular rim on which a locking annular rim formed on an outer surface of a body of an auxiliary container is locked along an inner circumferential surface of a lower part of the auxiliary container mounting member; the auxiliary container inserted into the lower part of the auxiliary container mounting member and closely assembled by an airtight ring provided on an outer circumferential surface of a lower assembly part, having the body formed by being concentrical with the inner circumferential surface of the auxiliary container mounting member on an upper part of the assembly part and formed with a discharge path configured to allow the two kinds of contents to flow down, and having the locking annular rim locked by the locking annular rim of the auxiliary container mounting member at an upper part of an outer circumferential surface of the body, and the contents discharge pumping member having a fixing member of a discharge pump that comprises a push button so as to enable pumping operation, the fixing member draping over the flange of the auxiliary container mounting member positioned at the opening part of the main container, and comprising the shoulder that enables the fixing member to be assembled and fixed to the opening part of the main container.

The auxiliary container mounting member may be configured to be narrowed while forming a step at an upper end thereof so as to minimize assembly friction, and at the same time may be configured to prevent the auxiliary container, which may be formed and assembled with a diameter that tapers downward a bottom thereof, from naturally being dropped due to its own weight.

The discharge path of the auxiliary container may be formed by cutting the body downward from the upper part of the body.

The piston may be provided with an airtight wing being in close contact with an inner circumferential surface of the main container and formed as an edge of a concave-type body, and the concave-type body may have a central part thereof formed in a concave shape and may be in close contact while surrounding the assembly part of the auxiliary container, so as to be able to discharge the mixed two kinds of contents without residual amount.

As described above, in the embodiment of the present disclosure, the airless type mixing container for two kinds of contents capable of discharging all the contents provides effects as follows:

Firstly, an auxiliary container mounting member 20 is configured and assembled in the main container 10 where one of the two kinds of contents is accommodated so that an auxiliary container 30 accommodating a content having a component different from that of the content accommodated in the main container 10 is positioned on a content receiving part 14 of a main container 10, wherein a structure is provided such that a flange 21 of the auxiliary container mounting member 20 is positioned in a state of draping over an opening part 11 of the main container 10, and at the same time an assembly part 33 including an airtight ring 34 is assembled at a lower part of a trunk 24 in which the auxiliary container 30 is tapered from wide at the top to narrow at the bottom. Accordingly, there is an advantage in that even when an additional load is generated in the auxiliary container 30, the auxiliary container 30 is not easily separated from the auxiliary container mounting member 20 and is stably assembled and maintained unless a coercive force is applied thereto, and there is an advantage in that when a push button 44 constituting the contents discharge pumping member 40 is deeply pressed when in use, the airtightness of the auxiliary container 30 is released from the contents discharge pumping member 40, thereby allowing the two kinds of contents to be mixed and used.

Secondly, since a concave-type body 51 of the piston 50 that pushes up the mixed two kinds of contents forms a concave part having a size capable of enclosing the assembly part 33 of the auxiliary container 30, a gap between the piston and the assembly part 33 of the auxiliary container 30 is minimized in a state where the mixed two kinds of contents in the content receiving part 14 of the main container 10 are completely pushed up, and the auxiliary container 30 is remounted to a lower end of the auxiliary container mounting member 20 by the piston 50, so that a lower end of the discharge pump 41 is in close contact with the bottom surface of the auxiliary container 30, in which the two kinds of contents remain as a residue, so as to discharge the two kinds of contents without residual amount, thereby improving product reliability from consumers.

Thirdly, a structure of the auxiliary container mounting member 20 on which the auxiliary container 30 is assembled is simplified to improve assembly productivity, and work of filling two kinds of contents in the auxiliary container 30 is performed with ease, and thus the embodiment of the present disclosure is very useful, thereby improving productivity of a product to be shipped.

### BRIEF DESCRIPTION OF THE DRAWINGS

FIG. 1 is a side view showing an assembly process of an airless type mixing container for two kinds of contents according to an embodiment of the present disclosure.

FIG. 2 is a side view showing a process of filling the contents in the airless type mixing container for two kinds of contents according to the embodiment of the present disclosure.

FIG. 3 is a cross-sectional view showing the airless type mixing container for two kinds of contents according to the embodiment of the present disclosure.

FIG. 4 is a side view showing a process of mixing two kinds of contents separately stored in the airless type mixing container for two kinds of contents according to the embodiment of the present disclosure.

FIG. 5 is an exemplary view showing a state in which all the mixed two kinds of contents of the airless type mixing container for two kinds of contents according to the embodiment of the present disclosure are discharged.

FIG. 6 is a perspective view showing an extract of an auxiliary container of the airless type mixing container for two kinds of contents according to the embodiment of the present disclosure.

FIGS. 7 to 8 are views of an exemplary embodiment according to the related art.

### DETAILED DESCRIPTION OF THE INVENTION

Hereinafter, a preferred exemplary embodiment for achieving the above objective will be described in detail with reference to the accompanying drawings.

In the embodiment of the present disclosure, an airless type mixing container for two kinds of contents capable of discharging all the contents includes: a main container 10 in which one of the two kinds of contents is filled; an auxiliary container mounting member 20 positioned inside the main container 10 to mount an auxiliary container 30; an auxiliary container 30 mounted to the auxiliary container mounting member 20 and filled with the other of the two kinds of contents; and a contents discharge pumping member 40 for discharging the mixed two kinds of contents.

The main container 10 is a through type, has a narrowed and stepped upper part thereof, and is provided with an opening part 11 formed with a screw thread having an outer circumferential surface on which a shoulder 42 of a content discharge pumping member 40 is assembled.

In a lower part of the main container where the piston 50 is assembled, a finishing cap 12 provided with an air inlet hole 13 is assembled and formed, and the content receiving part 14 in which one of the two kinds of contents is accommodated is formed.

In the auxiliary container mounting member 20 which is positioned in the content receiving part 14 of the main container 10, an upper flange 21 is locked on an upper edge part of the opening part 11 at an upper part of the main container 10, and a locking annular rim 22, in which a locking annular rim 32 formed on an outer surface of a body 31 of the auxiliary container 30 is locked, is formed along a lower inner circumferential surface of the auxiliary container mounting member.

The auxiliary container 30 mounted to the auxiliary container mounting member 20 is fitted into a lower part of the auxiliary container mounting member 20, and is airtightly assembled by an airtight ring 34 provided on an outer circumferential surface of the lower assembly part 33.

On an upper part of the assembly part 33, the body 31 having a discharge path 35 configured to allow the two kinds of contents to flow down into the content receiving part 14 of the main container 10 is formed concentrically with an inner circumferential surface of the auxiliary container mounting member 20.

At an upper part of an outer circumferential surface of the body 31, the locking annular rim 32 in which the locking annular rim 22 of the auxiliary container mounting member 20 is locked is formed.

In the contents discharge pumping member 40 mounted to the main container 10, a fixing member 43 of a discharge pump 41 that includes a push button 44 so as to enable pumping operation drapes over the flange 21 of the auxiliary container mounting member 20 which is positioned at the opening part 11 of the main container 10, and the discharge pump 41 in which the push button 44 is assembled to extend to a pumping piston rod 41a so as to enable the pumping operation includes a shoulder 42 to be assembled and fixed to the opening part 11 of the main container 10.

The auxiliary container mounting member 20 is configured to be narrowed while forming a step 23 at the upper end thereof so as to minimize assembly friction, and at the same time is configured to prevent the auxiliary container 30 from naturally being dropped due to its own weight, the auxiliary container being formed and assembled with a diameter that tapers downward the bottom thereof.

The discharge path 35 of the auxiliary container 30 is formed by cutting the body 31 downward from the upper part thereof and is configured to allow the two kinds of contents to flow down into the content receiving part 14 of the main container 10.

The piston 50 is provided with an airtight wing 52 being in close contact with an inner circumferential surface of the main container 10 and formed as an edge of the concave-type body 51, wherein the concave-type body 51 has a central part thereof formed in a concave shape and is in close contact with the assembly part 33 of the auxiliary container 30, the assembly part 33 being wrapped around by the concave-type body 51 so as to be able to discharge the mixed two kinds of contents without residual amount.

In the airless type mixing container for two kinds of contents capable of discharging all the contents configured as the above-described configuration, the piston 50 is mounted in the lower part of the main container 10.

The finishing cap 12 having the air inlet hole 13 is assembled at the lower part of the main container 10 in which the piston 50 is mounted.

When assembly of the main container 10 is completed, the auxiliary container mounting member 20 is mounted on the opening part 11.

Prior to assembling the auxiliary container mounting member 20 on the opening part 11, the auxiliary container 30 in which one of the two kinds of contents is filled is mounted at the lower part of the trunk 24 of the auxiliary container mounting member 20.

When mounting the auxiliary container 30 to the auxiliary container mounting member 20, the auxiliary container 30 is pushed from the bottom to the top in a state where the body 31 is made to face the top.

At this time, the locking annular rim 32 formed as the outer circumferential surface of the body 31 passes over the locking annular rim 22 formed as an inner circumferential surface of the trunk 24 of the auxiliary container mounting member 20, and when continually pushed up in the above-described state, the assembly part 33 including the airtight ring 34 is forcibly assembled by fitting into the lower part of the auxiliary container mounting member 20.

The auxiliary container mounting member 20 to which the auxiliary container 30 is assembled is mounted so as to be positioned in the content receiving part 14 through the opening part 11 of the main container 10.

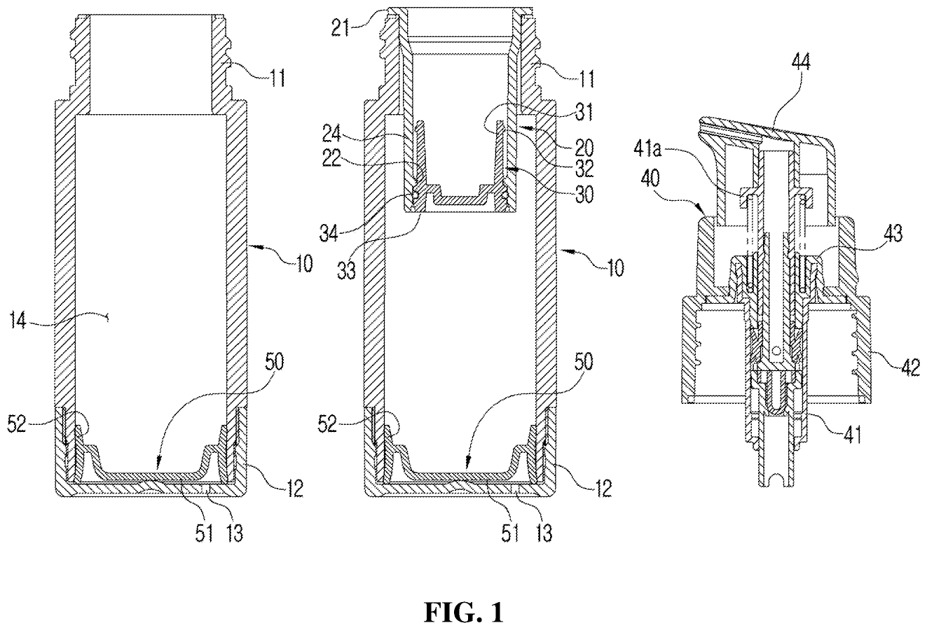

As described above, the contents discharge pumping member 40 is mounted on the main container 10 in a state where the auxiliary container 30 is mounted on the main container 10 (see FIG. 1).

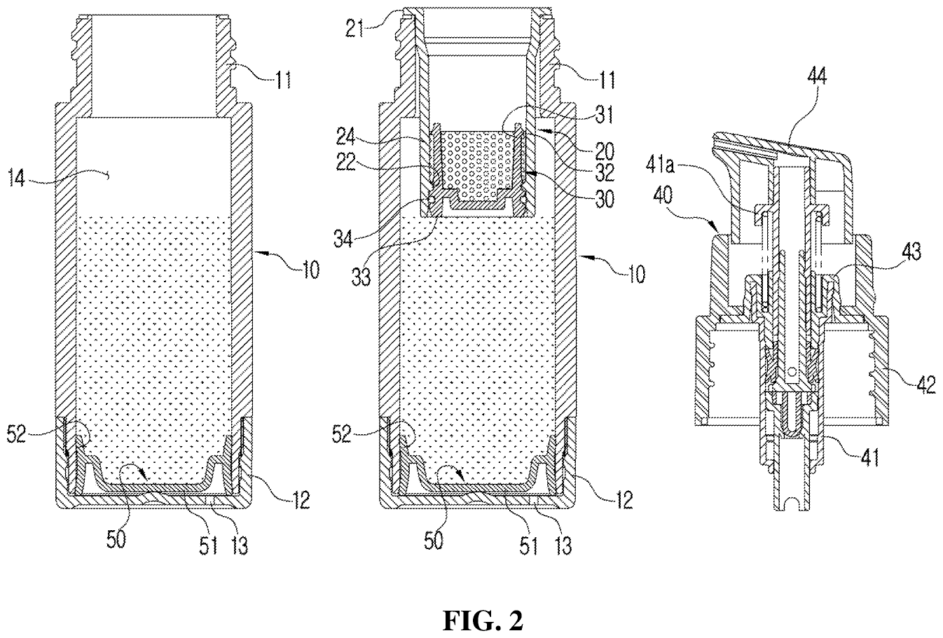

When two kinds of contents are to be filled and shipped in the airless type mixing container for two kinds of contents, capable of discharging all the contents, and being configured and assembled as described above, one of the two kinds of contents is filled first in the content receiving part 14 of the main container 10 as shown in FIG. 2.

Afterwards, the auxiliary container mounting member 20 in which the auxiliary container 30 is mounted is assembled through the opening part 11 of the main container 10 filled with the two kinds of contents.

The other of the two kinds of contents are filled in the auxiliary container 30 mounted on the main container 10 via the auxiliary container mounting member 20.

When filling of the two kinds of contents is completed, the shoulder 42 is fastened to the opening part 11 of the main container 10 to mount the contents discharge pumping member 40.

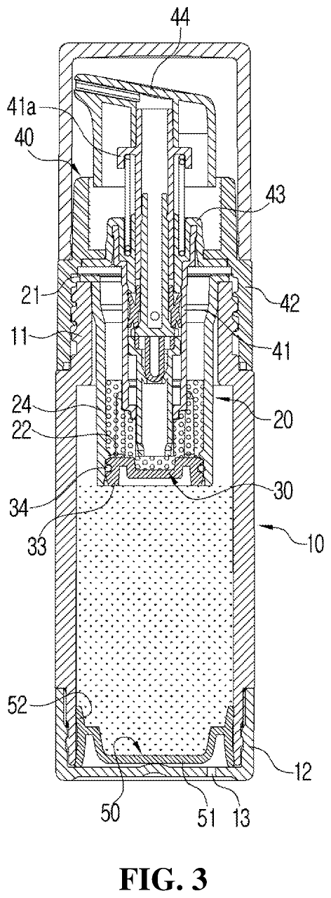

FIG. 3 is view showing a state in which the airless type mixing container for two kinds of contents of the embodiment of the present disclosure is shipped.

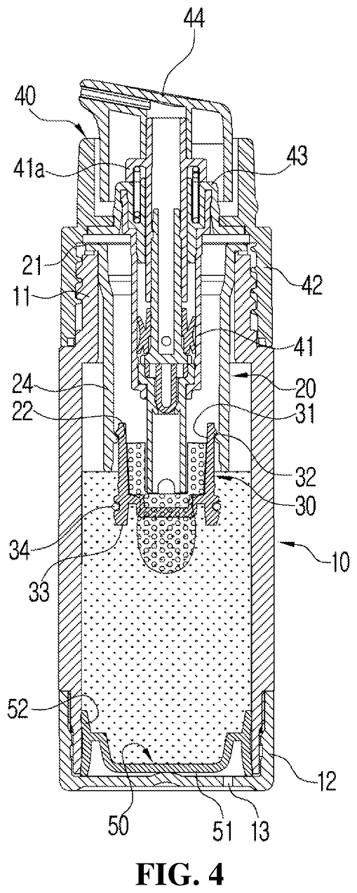

When mixing and using the two kinds of contents accommodated in the airless type mixing container for two kinds of contents of the embodiment of the present disclosure, the push button 44 is deeply pressed as shown in FIG. 4, so as to lower the discharge pump 41.

When the discharge pump 41 is lowered, the assembly part 33 of the auxiliary container 30 mounted on the trunk 24 of the auxiliary container mounting member 20 moves out of the trunk 24 of the auxiliary container mounting member 20.

At this time, one of the two kinds of contents flows down through the discharge path 35 formed in the body 31 of the auxiliary container 30 and is mixed with the contents accommodated in the content receiving part 14 of the main container 10.

In the lowering of the auxiliary container 30, the locking annular rim 32 formed on the outer circumferential surface of the body 31 is locked by the locking annular rim 22 of the trunk 24 of the auxiliary container mounting member 20, and stops the lowering.

The airless type mixing container for two kinds of contents is to be shaken, so that the two kinds of contents flowing from the auxiliary container 30 may be evenly mixed with the two kinds of contents in the content receiving part 14 of the main container 10.

When two kinds of contents are evenly mixed, the discharge pump 41 is operated by pressing the push button 44 of the contents discharge pumping member 40, so that as a vacuum is generated in the content receiving part 14 of the main container 10 and the contents are discharged. At this time, the piston 50 positioned in the content receiving part 14 of the main container 10 is pulled up by the vacuum.

As the piston 50 is pulled up, a state in which the two kinds of contents are adjacent to the discharge pump 41 of the contents discharge pumping member 40 is always maintained.

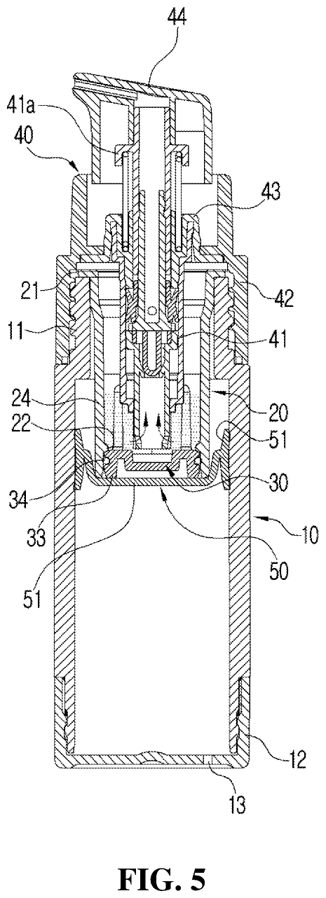

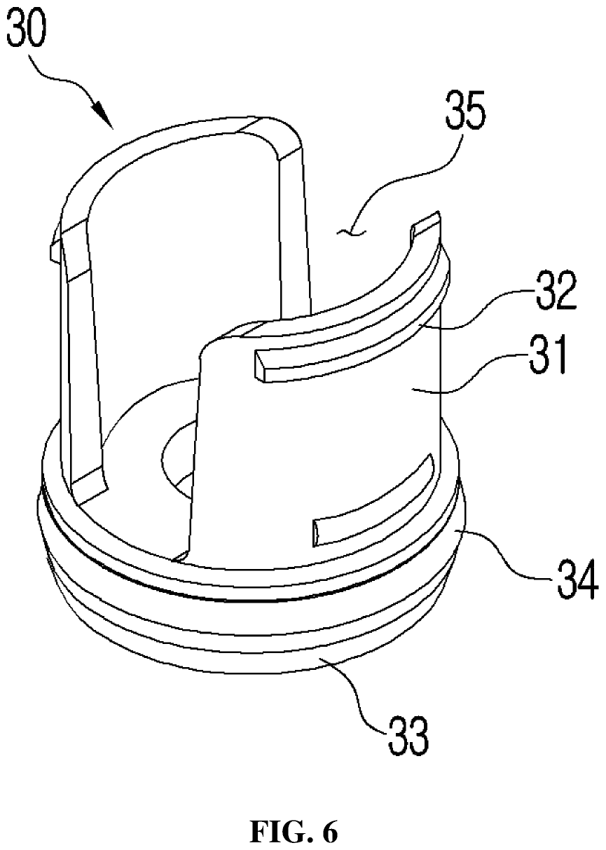

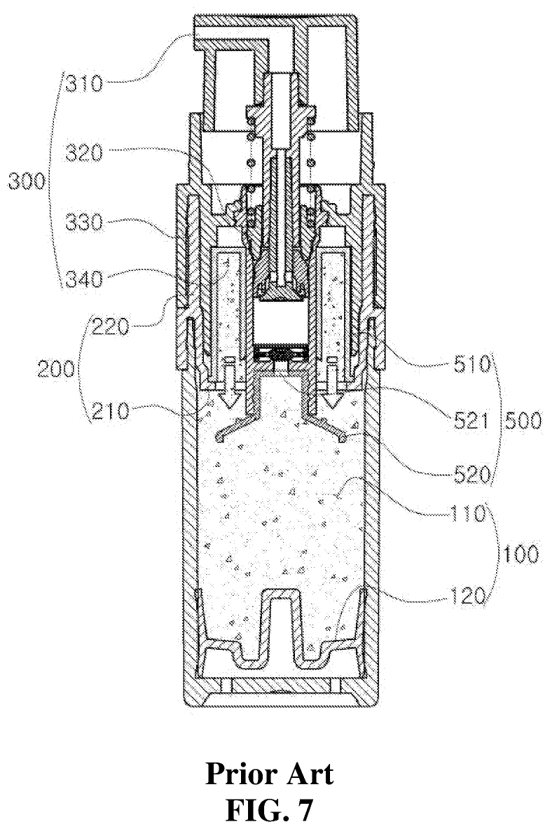

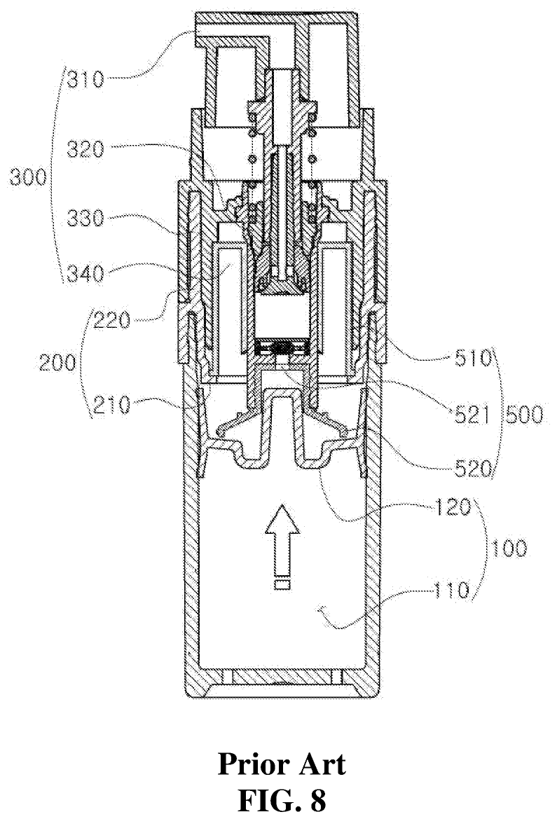

The piston 50 that is raised as described above is provided with the concave-type body 51 formed in a concave shape, thereby surrounding the assembly part 33 of the auxiliary container 30 at the time when discharging of the two kinds of contents is completed. In the above-described state, when the piston 50 continues to rise, the auxiliary container 30 is placed in a position, as the initially mounted position, at the lower part of the trunk 24 of the auxiliary container mounting member 20 as shown in FIG. 5.

The two kinds of contents in the auxiliary container 30 positioned as described above may be discharged without residual amount by the pumping operation of the discharge pump 41.

What is claimed is:

1. An airless type mixing container for two kinds of contents, in which the two kinds of contents are separately stored and are able to be used by mixing, the airless type mixing container being capable of discharging all the contents and comprising:
a main container having an opening part formed with a screw thread having an outer circumferential surface thereof on which a shoulder of a contents discharge pumping member is assembled, the opening part having a narrowed upper part thereof in a through-type tube shape, and having a finishing cap assembled therein and provided with an air inlet hole at a lower part thereof where a piston is assembled, the main container accommodating one of the two kinds of contents;
an auxiliary container mounting member being positioned inside of a content receiving part through the opening part at the upper part of the main container so that a flange at an upper part thereof is locked by an upper edge part of the opening part, and having a locking annular rim on which a locking annular rim formed on an outer surface of a body of an auxiliary container is locked along an inner circumferential surface of a lower part of the auxiliary container mounting member;
the auxiliary container inserted into the lower part of the auxiliary container mounting member and closely assembled by an airtight ring provided on an outer circumferential surface of a lower assembly part, having the body formed by being concentrical with the inner circumferential surface of the auxiliary container mounting member on an upper part of the assembly part and formed with a discharge path configured to allow the two kinds of contents to flow down, and having the locking annular rim locked by the locking annular rim of the auxiliary container mounting member at an upper part of an outer circumferential surface of the body, and
the contents discharge pumping member having a fixing member of a discharge pump that comprises a push button so as to enable pumping operation, the fixing member draping over the flange of the auxiliary container mounting member positioned at the opening part of the main container, and comprising the shoulder that enables the fixing member to be assembled and fixed to the opening part of the main container.

2. The airless type mixing container of claim 1, wherein the auxiliary container mounting member is configured to be narrowed while forming a step at an upper end thereof so as to minimize assembly friction, and at the same time is configured to prevent the auxiliary container, which is formed and assembled with a diameter that tapers downward a bottom thereof, from naturally being dropped due to its own weight.

3. The airless type mixing container of claim 1, wherein the discharge path of the auxiliary container is formed by cutting the body downward from the upper part of the body.

4. The airless type mixing container of claim 1, wherein the piston is provided with an airtight wing being in close contact with an inner circumferential surface of the main container and formed as an edge of a concave-type body, and
the concave-type body has a central part thereof formed in a concave shape and is in close contact while surrounding the assembly part of the auxiliary container, so as to be able to discharge the mixed two kinds of contents without residual amount.
